(19) United States
(12) Patent Application Publication
(10) Pub. No.: US 2011/0058130 A1
(43) Pub. Date: Mar. 10, 2011

(54) Liquid crystal display device and its manufacturing method

(76) Inventors: Yoshihiro Hashimoto, Matsusaka-shi (JP); Hidehiko Yamaguchi, Tsu-shi (JP); Takashi Iwamoto, Matsusaka-shi (JP); Takayuki Hayano, Matsusaka-shi (JP); Naoshi Yamada, Tsu-shi (JP); Toshihide Tsubata, Tsu-shi (JP)

(21) Appl. No.: 12/944,311

(22) Filed: Nov. 11, 2010

Related U.S. Application Data
(63) Continuation of application No. 11/077,216, filed on Mar. 11, 2005.

(30) Foreign Application Priority Data
Mar. 16, 2004 (JP) 2004-074555

(51) Int. Cl. G02F 1/1333

(52) U.S. Cl. 349/110

(57) ABSTRACT

A liquid crystal display device of the present invention is one in which unevenness of display, spots generated due to lowering of voltage retention because of impurity ions are sufficiently eliminated and reliability of long-time/long-term use is improved. A liquid crystal display device of the present invention is one comprising a first substrate and a second substrate configured via a liquid crystal layer and a seal,

wherein at least one of the first substrate and the second substrate comprises, towards the liquid crystal layer, a color filter layer, a transparent electrode and an alignment layer in this order and

at least one of the transparent electrode and the alignment layer covers the color filter layer in a non-display region.

### REFERENCE TO RELATED APPLICATIONS

This application is a continuation of Ser. No. 11/077,216 filed Mar. 11, 2005, which claims priority under 35 U.S.C. §119(a) to Patent Application No. 2004-074555 filed in Japan on Mar. 16, 2004, the entire contents of which are hereby incorporated by reference.

### BACKGROUND OF THE INVENTION

1. Field of the Invention

The present invention relates to a liquid crystal display device and its manufacturing method, and more particularly it relates to an active matrix system liquid crystal display device in which each of picture element electrodes arranged in a matrix form is selectively driven by active element, and its manufacturing method.

2. Description of the Related Art

Liquid crystal display device is indispensable to a means for displaying information or image, and recently, an active matrix system liquid crystal display device is widely used in applications such as TV and monitor. In such applications, a liquid crystal display device is lighted over a long time and further used over a long period of time, which leads to desire for further improvement in reliability of long time/long term use.

In an active matrix system liquid crystal display device, a display is largely influenced by voltage retention, it has been studied to sufficiently remove partial unevenness of display, spots and so forth caused by lowering of voltage retention by impurity ions in a panel, for example.

According to such a liquid crystal display device, color filter layers for carrying out color display are formed in one of two substrates in general. Colorization of display image is carried out by forming color filter layers of red color, green color, and blue color, which are light's three primary colors, and by forming red picture elements (pixels), green picture elements, and blue picture elements normally, and improvement of contrast is carried out by forming black mask layers (BMmember) having a high light blocking effect in a non-display region which is formed outside a display region and between the picture elements and preventing a light from leaking. In addition, a transparent electrode and an alignment layer are sequentially formed on the color filter layers.

According to a previous liquid crystal display device, in order to prevent display defect due to elution of impurity ions to a display region, improvement of reliability is tried by depositing dummy electrode or dummy pixel in a non-display region, applying a voltage to it and keeping impurity ions within the non-display region (refer to Japanese Kokai Publication Hei-04 -295824 (P. 2 and 3, FIG. 1) and Japanese Kokai Publication Hei-09-5780 (P. 2 and 5, FIG. 1), for example).

FIG. 6A is a plan view illustrating the liquid crystal display panel 50 in the previous liquid crystal display device. In addition, FIG. 6B is a sectional view illustrating a part of the panel 50 taken along line B-B′ in FIG. 6A. As illustrated in FIG. 6A, according to the previous art, influence of impurity ions on the display region 31 is prevented by depositing a dummy electrode or the dummy pixel 45 which is driven in the same manner as a pixel in the non-display region 32 between the display region 31 and the seal 33, applying a voltage to it, driving it, and keeping impurity ions within the non-display region 32.

However, there is room for improving about the following two points in this art.

(1) Elution of impurity ions is accelerated in a non-display region.

(2) Impurity ions kept by a dummy electrode or a dummy pixel enter a display region when power is OFF, and cause unevenness of luminance and spots.

Regarding (1), an electric field is generated in a non-display region because of a metal wiring of the first substrate or driving of a dummy electrode or a dummy pixel, and this electric field derives impurity ions attached on a BM in the non-display region or impurity ions from the BM or a seal itself. As a result, elution of impurity ions is accelerated.

Regarding (2), although impurity ions are kept within a non-display region by applying a voltage to a dummy electrode or a dummy pixel, the kept impurity ions enter a display region when power is OFF, in previous arts.

In this respect, when liquid crystal display devices are used in TV and so forth which are used for a long period of time and turned ON and OFF many times, since sufficient reliability may not be provided in the method of trapping impurity ions by a dummy electrode or a dummy pixel in the previous liquid crystal display device, it is demanded that the unevenness of display, spots and so forth due to lowering of voltage retention caused by impurity ion are eliminated, and reliability of long-time/long-term use is further improved in an active matrix system liquid crystal display device and so forth.

### SUMMARY OF THE INVENTION

The present invention was made in view of the above situation, and has an object to provide a liquid crystal display device in which unevenness of display, spots, and so forth generated due to lowering of voltage retention because of impurity ions are sufficiently eliminated and reliability of long-time/long-term use is improved, and its manufacturing method.

The inventors of the present invention studied about a structure of the liquid crystal display device in which unevenness of display, spots and so forth may be eliminated, and found that the unevenness of display, spots due to lowering of voltage retention are caused by elution of impurity ions from a non-display region around a display region into a display region in many cases, which results from elution of impurity ions attached on a BM surface in the non-display region or elution of impurity ions from the BM member or a seal itself due to an electric field generated by drive of pixels in the display region adjacent to the non-display region or a metal wiring in the non-display region. In addition, they focus attention on that since a transparent electrode and an alignment layer are not formed in the non-display region, a color filter layer is in contact with a liquid crystal layer in the non-display region, and impurity ions attached on the BM surface of the color filter layer or impurity ion eluted from the BM member itself enter the liquid crystal layer. Thus, they found that prevention of elution of impurity ions itself is effective in obtaining sufficient reliability of long-time/long-term use, that is, instead of keeping eluted impurity ions within the non-display region so as not to prevent influence of them on a display region in previous arts, prevention of elution of impurity ion to a liquid crystal layer is effective in improvement of reliability, and is particularly effective in application to TV and so forth which are used for a long period of time and turned ON and OFF many times. Thus, the above object is achieved by covering a color filter layer in a non-display region with at least one of a transparent electrode, an alignment layer and a member comprised of same material as a member for controlling alignment directions of liquid crystal molecules. And the present invention is achieved.

That is, the present invention provides a liquid crystal display device comprising a first substrate and a second substrate configured via a liquid crystal layer and a seal,

wherein at least one of the first substrate and the second substrate comprises, towards the liquid crystal layer, a color filter layer, a transparent electrode and an alignment layer in this order and

at least one of the transparent electrode and the alignment layer covers the color filter layer in a non-display region.

The present invention also provides a liquid crystal display device comprising a first substrate and a second substrate configured via a liquid crystal layer and a seal,

wherein at least one of the first substrate and the second substrate comprises, towards the liquid crystal layer, a color filter layer, a transparent electrode and an alignment layer in this order and

a member for controlling alignment directions of liquid crystal molecules and a member for covering the color filter layer in the non-display region are provided, and

the member for covering the color filter layer in the non-display region is comprised of same material as the member for controlling the alignment direction of the liquid crystal molecules.

The present invention further provides a liquid crystal display device comprising a first substrate and a second substrate configured via a liquid crystal layer and a seal,

wherein at least one of the first substrate and the second substrate comprises, towards the liquid crystal layer, a color filter layer, a transparent electrode and an alignment layer in this order and

a columnar spacer for forming a cell gap of a liquid crystal panel and a member for covering the color filter layer in a non-display region are provided, and

the member for covering the color filter layer in a non-display region is comprised of same material as the columnar spacer.

### BRIEF DESCRIPTION OF THE DRAWINGS

FIG. 1A is a plan view illustrating a liquid crystal display panel constituting a liquid crystal display device of the present invention (embodiment 1).

FIG. 1B is a sectional view illustrating the liquid crystal display panel taken along line A-A′ of FIG. 1A (embodiment 1).

FIG. 2 is a sectional view illustrating a liquid crystal display panel according to an embodiment of the present invention (embodiment 2).

FIG. 3 is a sectional view illustrating a liquid crystal display panel according to another embodiment of the present invention (embodiment 3).

FIG. 4 is a sectional view illustrating a liquid crystal display panel according to still another embodiment of the present invention (embodiment 4).

FIG. 5A is a plan view illustrating a liquid crystal display panel according to still another embodiment of the present invention (embodiment 5).

FIG. 5B is an enlarged view of a part (a filling port part) surrounded by the circular broken line of FIG. 5A (embodiment 5).

FIG. 6A is a plan view illustrating a liquid crystal display panel constituting a previous liquid crystal display device.

FIG. 6B is a sectional view illustrating the liquid crystal display panel taken along line B-B′ of FIG. 6A.

### EXPLANATION OF SYMBOLS AND NUMERALS

1, 31: Display region

2, 32: Non-display region

3, 33: Seal member

4, 34: First substrate

4a, 34a: First supporting substrate

5, 35: Second substrate

5a, 35a: Second supporting substrate

6, 36: Insulating layer

7, 37: Thin film transistorized circuitry layer (TFT circuitry layer)

8, 38: Picture element electrode

9, 39: Alignment layer

10, 40: Transparent electrode (Common electrode)

11, 41: Color layer

12, 42: BM member

13, 43: Color filter layer

14, 44: Liquid crystal layer

15: Projection for controlling alignment directions of liquid crystal molecules

16: Member comprised of the same material as the projection 15

17: Filling port

18: Boundary line of a part formed with an alignment layer

20-24, 50: Liquid crystal display panel

45: Dummy pixel or dummy electrode

### DESCRIPTION OF THE PREFERRED EMBODIMENTS

According to a liquid crystal display device of the present invention, a first substrate and a second substrate are aligned via a seal member, and space formed by a pair of the substrates and the seal member, is filled with liquid crystals to form a liquid crystal layer. The first substrate and the second substrate comprise a display region and a non-display region around the display region and a seal part is provided in the non-display region.

According to the liquid crystal display device, the first substrate preferably has a structure in which a transparent electrode is formed on a surface of the first supporting substrate, and the second substrate opposed to the first substrate preferably has a structure in which a color filter layer, a transparent electrode and an alignment layer are formed on a surface of the second supporting substrate in this order toward the liquid crystal layer, for example. As the liquid crystal display device having this structure, there is a liquid crystal display device in TN (Twisted Nematic) mode, one in VA (Vertical Alignment) and so forth. In addition, there is a liquid crystal display device in which an electrode is deposited in a first substrate but the electrode and the like are not deposited in a second substrate, such as a liquid crystal display device in IPS (In Plain Switching) mode.

According to a liquid crystal display device of the present invention,

(1) at least one of the first substrate and the second substrate comprises, towards the liquid crystal layer, a color filter layer, a transparent electrode and an alignment layer in this order and

at least one of the transparent electrode and the alignment layer covers the color filter layer in a non-display region, or

(2) at least one of the first substrate and the second substrate comprises, towards the liquid crystal layer, a color filter layer, a transparent electrode and an alignment layer in this order and

a member for controlling alignment directions of liquid crystal molecules and a member for covering the color filter layer in the non-display region are provided, and

the member for covering the color filter layer in the non-display region is comprised of same material as the member for controlling the alignment direction of the liquid crystal molecules.

A protrusion is pointed to as an example of the member for controlling alignment directions of liquid crystal molecules.

Thus, elution of impurity ions may be prevented since the color filter layer has the liquid crystal layer side covered with at least one of the alignment layer and so forth. In addition, it is allowable that the structures of (1) and (2) are combined, that is, at least one of the transparent electrode, the alignment layer and the member for covering the color filter layer in the non-display region cover the color filter layer in the non-display region. In addition, it is allowable that the color filter layer in the non-display region is covered with another layer such as resin film constituting a columnar spacer.

Thus, the present invention also provide a liquid crystal display device comprising a first substrate and a second substrate configured via a liquid crystal layer and a seal,

wherein at least one of the first substrate and the second substrate comprises, towards the liquid crystal layer, a color filter layer, a transparent electrode and an alignment layer in this order and

a columnar spacer for forming a cell gap of a liquid crystal panel and a member for covering the color filter layer in a non-display region are provided, and

“Covering the color filter layer” in the present invention, means that part or whole of the color filter layer in the non-display region is covered such that elution of impurity ions to the liquid crystal layer may be substantially prevented. Preferably, whole of the color filter layer in the non-display region including a side face is covered so as not to be in contact with the liquid crystal layer.

“Comprising, towards the liquid crystal layer, a color filter layer, a transparent electrode and an alignment layer in this order” means that the color filter layer, the transparent electrode and the alignment layer are formed in this order from the supporting substrate toward the liquid crystal layer and it is allowable that another layer or another member is formed between those layers or on surfaces thereof.

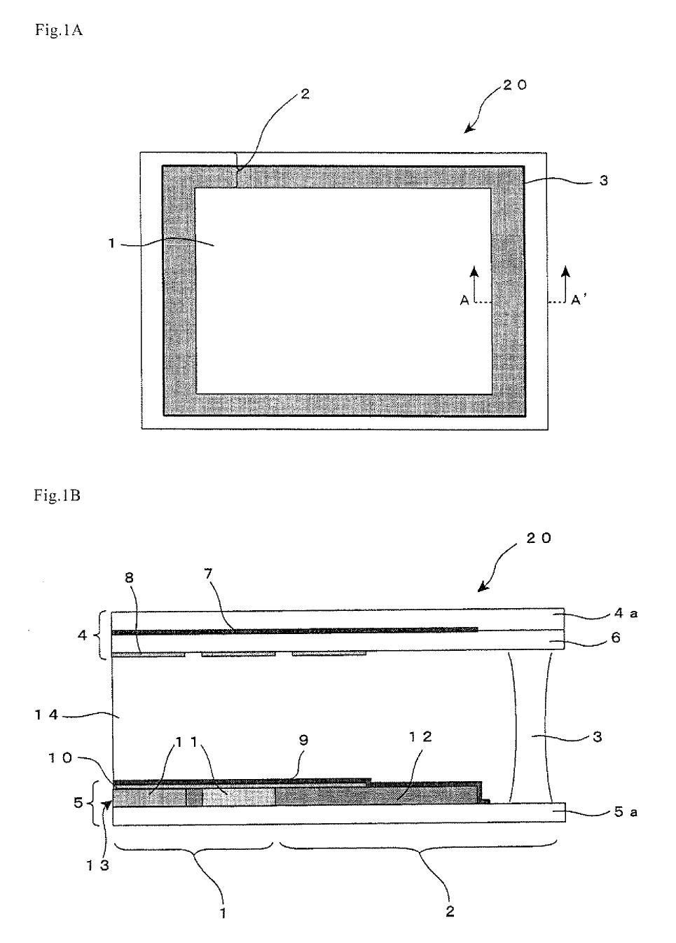

A preferable embodiment of a liquid crystal display panel constituting such liquid crystal display device is illustrated in FIGS. 1A and 1B. FIG. 1A is a schematic plan view illustrating a liquid crystal display panel 20 constituting a liquid crystal display device of the present invention, and FIG. 1B is a schematic sectional view illustrating a part of the display region 1 and the non-display region 2 of the liquid crystal display panel 20 taken along line A-A′ of FIG. 1A.

According to the present invention, for example, as illustrated in a plan view of a liquid crystal display panel of FIG. 1A, the display region 1 and the non-display region 2 around the display region 1 are provided, and the seal member 3 is provided in the non-display region 2. In addition, as illustrated in a sectional view of FIG. 1B, elution of impurity ions attached on the surface of the BM member 12 to the liquid crystal layer 14 and elution of impurity ions from the BM member 12 itself to a liquid crystal layer 14 may be prevented by covering whole surface of the BM member 12 of the color filter layer 13 formed in the non-display region 2 with the alignment layer 9, for example. It is allowable that whole surface of the BM member 12 of the color filter layer 13 in the non-display region 2 may be covered with the transparent electrode 10, a member comprised of a same material as a protrusion for controlling alignment directions of liquid crystal molecules in VA mode, and so forth other than the alignment layer 9.

When the liquid crystal layer comes in contact with the color filter layer in the liquid crystal display device, since elution of impurity ions occurs at an interface thereof. Therefore, elution of impurity ions to a liquid crystal layer may be prevented, by forming an alignment layer, a transparent electrode, a member comprised of a same material as a protrusion used in VA mode, and so forth between the liquid crystal layer and a color filter layer, covering whole of the color filter layer and eliminating a region in which the liquid crystal layer is directly in contact with the color filter layer, so improvement of reliability may be carried out.

Preferable embodiments of the present invention will be described hereinafter.

According to the present invention, it is preferable that at least one of the transparent electrode, the alignment layer and the member for covering the color filter layer in the non-display region is formed up to a sealed region. Thus, elution of impurity ions from the color filter layer may be more sufficiently prevented by not only covering the color filter layer with the alignment layer and so forth, but also forming the alignment layer and so forth up to the sealed region.

According to the present invention, it is also preferable that the liquid crystal display device comprises a filling port for vacuum injection of a liquid crystal, and

at least one of the transparent electrode, the alignment layer and the member for covering the color filter layer in the non-display region is formed up to the filling port part. When the liquid crystal is filled in between the substrates by vacuum injection to manufacture the liquid crystal display device, contact between the color filter layer and the liquid crystal at the time of injecting the liquid crystal, may be prevented by forming the alignment layer and so forth up to the filling port part of the liquid crystal, so that impurity ions may be further sufficiently prevented from mixing in the liquid crystal layer.

According to the present invention, it is additionally preferable the transparent electrode and the alignment layer cover the color filter layer in the non-display region. In this case, since the color filter layer in the non-display region is doubly covered with alignment layer and transparent electrode, elution of impurity ions from the color filter layer may be sufficiently prevented. It is more preferable that the transparent electrode and the alignment layer are formed up to a sealed region. In addition, it is allowable that all of the transparent electrode, the alignment layer and the member for covering the color filter layer in the non-display region cover the color filter layer in the non-display region or that all of them are formed up to the sealed region.

The present invention also provides a method of manufacturing the liquid crystal display device comprising a first substrate and a second substrate configured via a liquid crystal layer and a seal,

at least one of the first substrate and the second substrate comprising, towards the liquid crystal layer, a color filter layer, a transparent electrode and an alignment layer in this order,

a member for controlling alignment directions of liquid crystal molecules and a member for covering the color filter layer in the non-display region being provided,

the member for covering the color filter layer in the non-display region being comprised of same material as the member for controlling the alignment direction of the liquid crystal molecules,

wherein the method of manufacturing the liquid crystal display device comprises a step of forming the member for controlling the alignment direction of the liquid crystal molecules and the member for covering the color filter layer in the non-display region at the same time.

The method of manufacturing the liquid crystal display device is preferable as a method of manufacturing the above-mentioned liquid crystal display device in which the color filter layer in the non-display region is covered with the member comprised of same material as the member for controlling the alignment direction of the liquid crystal molecules. The liquid crystal display device, in which reliability of long-time/long-term use may be improved, may be effectively manufactured by forming the member for controlling the alignment direction of the liquid crystal molecules and the member for covering the color filter layer in the non-display region at the same time.

In addition, the present invention also provides a method of manufacturing the liquid crystal display device comprising a first substrate and a second substrate configured via a liquid crystal layer and a seal,

at least one of the first substrate and the second substrate comprising, towards the liquid crystal layer, a color filter layer, a transparent electrode and an alignment layer in this order,

a columnar spacer for forming a cell gap of a liquid crystal panel and a member for covering the color filter layer in a non-display region being provided,

the member for covering the color filter layer in a non-display region being comprised of same material as the columnar spacer,

wherein the method of manufacturing the liquid crystal display device comprises a step of forming the columnar spacer and the member for covering the color filter layer in the non-display region at the same time.

The method of manufacturing the liquid crystal display device is preferable as a method of manufacturing the above-mentioned liquid crystal display device in which the color filter layer in the non-display region is covered with the member comprised of same material as the columnar spacer. The liquid crystal display device, in which reliability of long-time/long-term use may be improved, may be effectively manufactured by forming the columnar spacer and the member for covering the color filter layer in the non-display region at the same time.

A liquid crystal display device of the present invention has an above-mentioned structure and has a structure in which elution of impurity ions from a color filter layer in a non-display region may be prevented, the unevenness of display, spots and so forth generated due to lowering of voltage retention caused by impurity ions maybe sufficiently eliminated, and reliability of long-time/long-term use may be improved. As a result, the liquid crystal display device of the present invention may keep better display quality than that of previous liquid crystal display device.

In addition, according to a method of manufacturing the liquid crystal display device of the present invention, such liquid crystal display device maybe effectively manufactured.

Although examples of the present invention will be hereinafter described in detail, the present invention is not limited to the examples only.

### EMBODIMENT 1

The liquid crystal display panel 20 illustrated in FIG. 1A and 1B is a panel constituting an active matrix system liquid crystal display device and so forth, and comprises the first substrate 4 and the second substrate 5.

The first supporting substrate 4a is a transparent substrate such as glass substrate or plastic substrate, and the first substrate 4 has a structure in which the TFT circuitry layer 7 comprising TFT element, source electrode, gate electrode, electrode for storage capacitor and so forth, the insulating layer 6, the picture element electrode 8 and alignment layer (not illustrated) are deposited on the first supporting substrate 4a in this order towards the liquid crystal layer 14. The supporting second substrate 5a is a transparent substrate such as glass substrate or plastic substrate, and the second substrate 5 has a structure in which the color filter layer 13, the transparent electrode 10 and the alignment layer 9 are deposited on the second supporting substrate 5a in this order towards the liquid crystal layer 14.

The first substrate 4 and the second substrate 5 are aligned via the seal member 3 which contains glass beads (not illustrated) and is deposited in the vicinity of the substrate, and plastic beads (not illustrated) for controlling a cell gap, and space formed by the seal member 3, the first substrate 4 and the second substrate 5 is filled with liquid crystals to form the liquid crystal layer 14.

In addition, although a spherical spacer is used in this embodiment, it is allowable that a columnar spacer is provided in at least one of the first substrate 4 and the second substrate 5 instead of the above-mentioned spacer.

Liquid crystal molecules in the liquid crystal layer 14 exist so as to have a structure in which they are arranged parallel to the first supporting substrate 4a and the second supporting substrate 5a and form a spiral with the spiral angle of 90 to 360° between the first substrate 4 and the second substrate 5 in TN mode, or exist so as to have a structure in which they are arranged perpendicular to the first supporting substrate 4a and the second supporting substrate 5a, between the first substrate 4 and the second substrate 5 in VA mode. Two polarizers (not illustrated) are provided so as to sandwich the above-constituted liquid crystal display panel 20.

According to the embodiment of the present invention illustrated in FIG. 1A and 1B, display mode of the liquid crystal display panel 20 is TN mode. The color filter layer 13 in the second substrate 5 comprises the BM members 12 (BM layers) and the color films 11 having three colors R, G and B (red, green and blue) arranged so as to correspond to each picture element electrode 8 in the first substrate 4. Film thickness of the color filter layer 13 used in the present invention is preferably 1.0 to 2.0 μm.

The BM members 12 are formed of Cr, photosensitive resin material having light shielding effect, for example, and are provided so as to separate each of color films 11 in order to prevent the colors R, G and B of the color films 11 of the color filter layer 13 from being mixed.

In the second substrate 5 comprising the BM members 12, a layer of negative photosensitive resin material in which one of red pigment, green pigment and blue pigment is spread, is formed by a spin coating method, a printing method, a film laminating method and so forth so as to have a predetermined thickness, and only a predetermined position is exposed with UV (ultra violet) light having a specific wavelength using a mask from the surface, and then developed to form the color films comprising one color of R, G and B. Then, the above process is repeated three times to form the color films 11 comprising the three colors R, G and B.

The transparent electrode 10 and the alignment layer 9 are formed on the color filter layer 13 in this order towards the liquid crystal layer 14.

According to the embodiment of the present invention, the transparent electrode 10 is formed in the display region 1 and part of the non-display region 2. The alignment layer 9, which is formed next to the transparent electrode 10 in the second substrate 5, is also formed in both the display region 1 and the non-display region 2 so as to cover all the BM members 12 of the color filter layer 13 in the non-display region 2. The alignment layer 9 is preferably formed of polyimide compound, and the seal member 3 is preferably formed of mixture of epoxy resin and acryl resin, for example.

Although the alignment layer 9 is not formed between the second supporting substrate 5a and the seal member 3 in this embodiment of the present invention illustrated in FIG. 1, it is allowable that the alignment layer 9 is formed until it comes into contact with a sealed region (seal member 3) or until it overlaps with the sealed region (it overlaps with part or whole of the sealed region).

In previous liquid crystal display devices, display defect caused by impurity ions is generated in some cases when they are continuously energized for 1000 hours in a burn-in acceleration test under a high temperature. Meanwhile, according to the liquid crystal display device of the present invention, display defect caused by impurity ions is not generated even when it is continuously energized for 1000 hours or more.

### EMBODIMENT 2

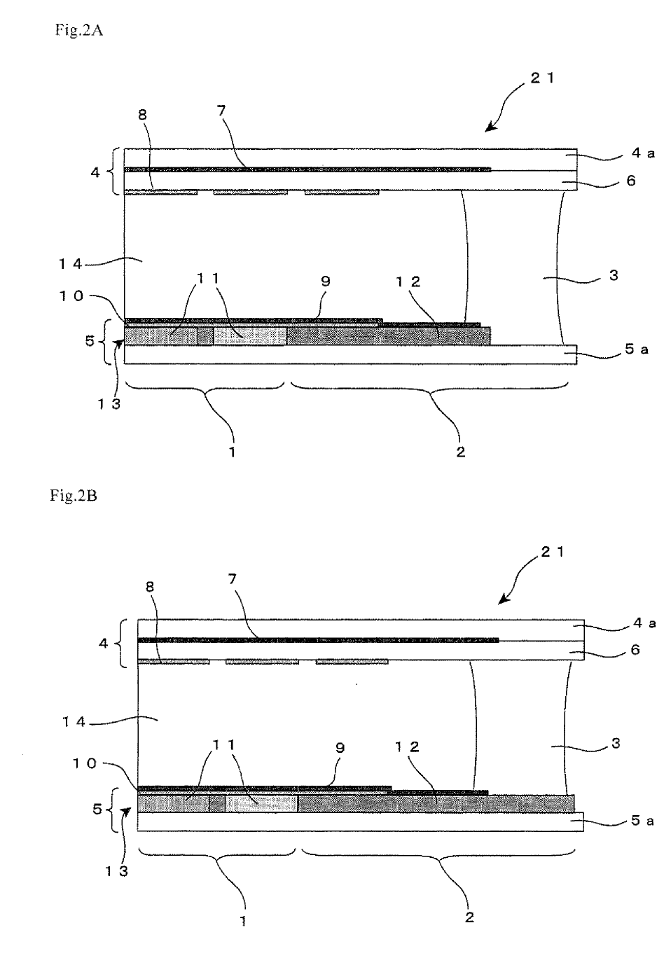

Each of FIGS. 2A and 2B is a schematic sectional view illustrating structure of the liquid crystal display panel 21 which constitutes a liquid crystal display device according to another embodiment of the present invention. Hereinafter, a description of the same component as the liquid crystal display panel 20 illustrated in FIG. 1A and 1B will be omitted.

In the liquid crystal display panel 20 illustrated in FIG. 1B, the seal member 3 is not in contact with the color filter layer 13 in the second substrate 5, but in the liquid crystal display panel 21 illustrated in FIG. 2A, the seal member 3 is in contact with a color filter layer 13 in the second substrate 5. The alignment layer 9, which is formed on the color filter layer 13 in the non-display region 2, is formed until it comes in contact with the seal member 3, and the liquid crystal layer 14 is not directly in contact with the color filter layer 13. It is allowable that the alignment layer 9 is formed until it overlaps with a sealed region.

In this structure, if manufacturing margins of formation of the alignment layer 9, formation of the seal member 3 and alignment of the first substrate 4 and the second substrate 5 is considered, it is more preferable that the alignment layer 9 covers the sealed region by 400 μm or more, that is, the alignment layer 9 overlaps with the sealed region by 400 μm or more, when variation in positional relation between the alignment layer 9 drawn by a printing method and the seal member 3 drawn by a printing method is about ±400 μm, in order to provide a structure in which the liquid crystal layer 14 is not directly in contact with the color filter layer 13.

Also, in the liquid crystal display panel 20 illustrated in FIG. 1, the seal member 3 is not in contact with the color filter layer 13 in the second substrate 5. However, in the liquid crystal display panel 21 illustrated in FIG. 2B, the seal member 3 is in contact with the color filter layer 13 in the second substrate 5 and the color filter layer 13 is formed up to outer side of the sealed region. That is, the color filter layer 13 is formed so as to overlap with whole of the sealed region.

In this case, the liquid crystal layer 14 is not directly in contact with the color filter layer 13 by forming the alignment layer 9 on the color filter layer 13 until alignment layer 9 comes into contact with the seal part (seal member 3) as illustrated in FIG. 2B and preventing elution of impurity ions from the color filter layer 13 to the liquid crystal layer 14. It is allowable that the alignment layer 9 is also formed until it overlaps with whole of the sealed region.

According to Embodiment 2, the same effect as Embodiment 1 may be provided.

### EMBODIMENT 3

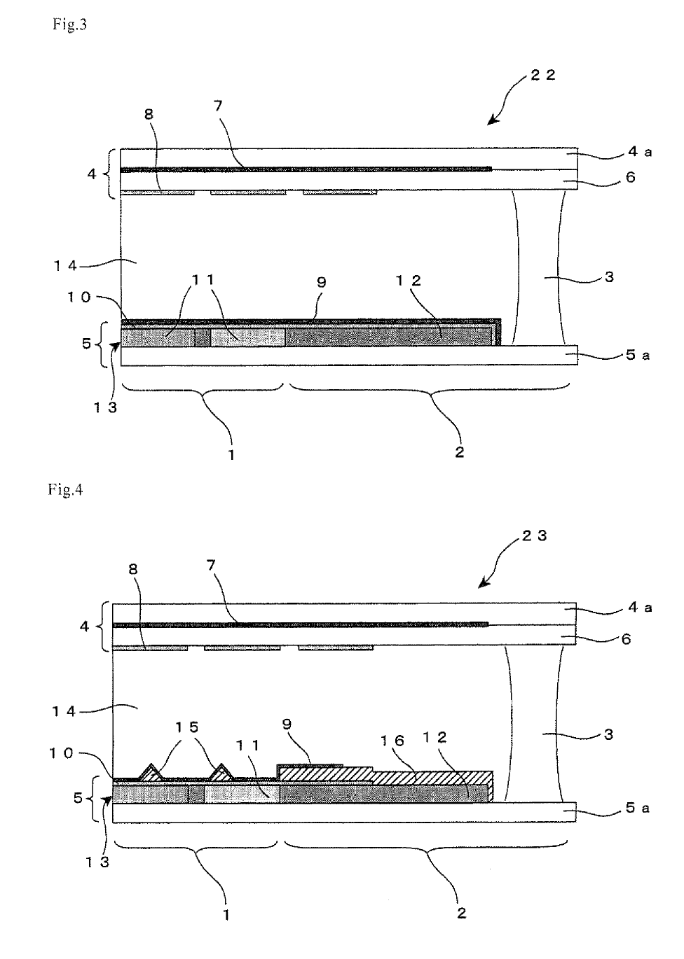

FIG. 3 is a schematic sectional view illustrating a structure of the liquid crystal display panel 22 according to another embodiment of the present invention. Hereinafter, a description of the same component as liquid crystal display panel 20 illustrated in FIG. 1A and 1B will be omitted.

In the liquid crystal display panel 20 illustrated in FIG. 1, the transparent electrode 10 is formed on part of the color filter layer 13 in the non-display region 2, but in the liquid crystal display panel 22 illustrated in FIG. 3, the transparent electrode 10 and the alignment layer 9 are formed at least on the liquid crystal layer 14 side of the color filter layer 13 in the non-display region 2. That is, whole of the color filter layer 13 is covered with the transparent electrode 10, and whole of the transparent electrode 10 is covered with the alignment layer 9. Thus, effect of preventing elution of impurity ions to the liquid crystal layer 14 may be improved by forming the transparent electrode 10 and the alignment layer 9 between the liquid crystal layer 14 and the color filter layer 13.

Although the transparent electrode 10 and the alignment layer 9 are formed at least on the liquid crystal layer 14 side of the color filter layer 13 and they are not formed in a sealed region in the liquid crystal display panel 22 illustrated in FIG. 3, it is allowable that they are formed until they come into contact with the sealed region or overlap with the sealed region.

According to Embodiment 3 of the present invention, the same effect as Embodiment 1 may be provided.

### EMBODIMENT 4

FIG. 4 is a schematic sectional view illustrating a structure of the liquid crystal display panel 23 according to another embodiment of the present invention. Hereinafter, a description of the same component as the liquid crystal display panel 20 illustrated in FIG. 1 will be omitted.

According to an embodiment in FIG. 4, display mode of the liquid crystal display panel 23 is VA mode. In VA mode, in order to control alignment directions of liquid crystal molecules, the projections 15 formed of photosensitive resin material are deposited on the transparent electrode 10 in the second substrate 5, for example. That is, the transparent electrode 10, the projections 15 and the alignment layer 9 are formed on the color filter layer 13 in this order towards the liquid crystal layer 14 in the second substrate 5. For example, the transparent electrode 10 is formed on color filter layer 13, a layer of negative photosensitive resin material or positive photosensitive resin material is formed by a spin coating method, a printing method, a film laminating method and so forth so as to have a predetermined thickness, only a predetermined part is exposed to UV light having a specific wavelength using a mask from the surface, and developed to form the projections 15 for controlling alignment directions on the transparent electrode 10.

The film thickness of the projections 15 for controlling alignment directions in the present invention is preferably 0.5 to 1.5 μm. The projections 15 are formed so as to have a predetermined pattern to control alignment directions of liquid crystal molecules, and the alignment layer 9 is formed thereon in the display region 1.

In the liquid crystal display panel 20 illustrated in FIG. 1, the alignment layer 9 is formed on whole of the color filter layer 13 in the non-display region 2, but in the liquid crystal display panel 23 illustrated in FIG. 4, the member 16 for covering the color filter layer 13, formed of the same material as the projections 15 for controlling alignment directions of liquid crystal molecules, is formed at least on the liquid crystal layer 14 side of the color filter layer 13 in the non-display region 2.

In addition, instead of the member 16 formed of the same material as the projections 15, it is allowable that a film comprising same resin material as a columnar spacer covers the liquid crystal layer 14 side of the color filter layer 13. In the liquid crystal display panel 23 illustrated in FIG. 4, the member 16 formed of the same material as the projections 15 covers the liquid crystal layer 14 side of the color filter layer 13 and it is not formed up to a sealed region, but it is allowable that the projections 15 and the member 16 are formed until they come in contact with the sealed region or until they overlap with the sealed region.

Although it is not illustrated in FIG. 4, in order to further improve the effect of preventing elution of impurity ions from the color filter layer 13 to the liquid crystal layer 14, it is allowable that the second substrate 5 has a structure in which three layers comprised of the member 16, the transparent electrode 10 and the alignment layer 9 are formed so as to cover the liquid crystal layer 14 side of the color filter layer 13. That is, it is allowable that the alignment layer 9 is formed so as to cover the member 16 in FIG. 4. In addition, it is allowable that the transparent electrode 10 is formed so as to cover the color filter layer 13 in the non-display region.

According to Embodiment 4 of the present invention, the same effect as Embodiment 1 may be provided.

### EMBODIMENT 5

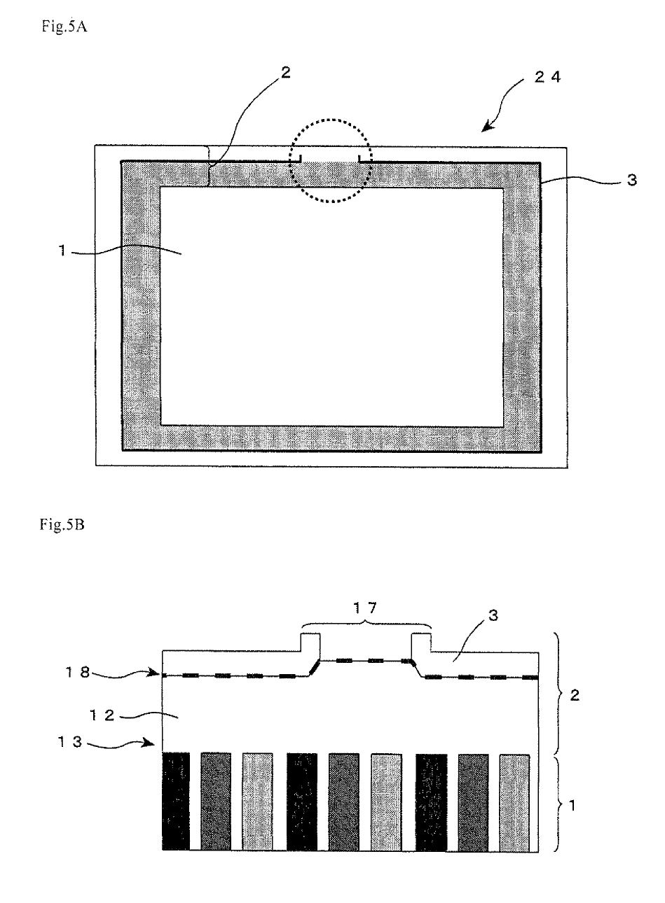

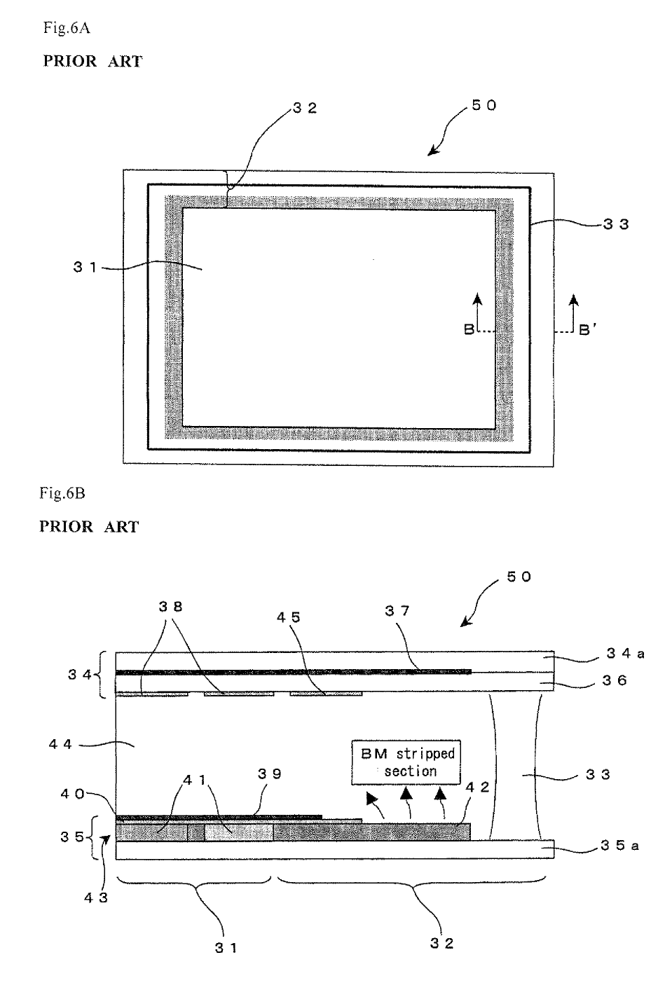

FIG. 5A is a schematic plan view illustrating a structure of the liquid crystal display panel 24 according to another embodiment of the present invention, and FIG. 5B is an enlarged view illustrating a part (a filling port part) surrounded by a circular broken line of FIG. 5A. Hereinafter, a description of the same component as the liquid crystal display panel 20 illustrated in FIG. 1 will be omitted.

According to an embodiment in FIG. 5, a filling port part 17 for vacuum injection is formed, and a liquid crystal is injected by vacuum injection.

Since impurity ions are eluted at the time of injecting a liquid crystal if the liquid crystal layer comes in contact with the color filter layer 13, the alignment layer, the transparent electrode or the member formed of same material as the projections for alignment directions of liquid crystal molecules in VA mode covers whole of the color filter layer 13 in the filling port part 17. The alignment layer, the transparent electrode or the member formed of same material as the projections for alignment directions of liquid crystal molecules is formed at least up to the boundary line (broken line) 18 of the part formed with an alignment layer in FIG. 5B.

In this case, any one of the alignment layer 9, the transparent electrode and the member formed of the same material as the projections, any two of them, or all of them may cover whole of the color filter layer 13.

1. A liquid crystal display device comprising
a first substrate and a second substrate configured via a liquid crystal layer and a seal,
wherein at least one of the first substrate and the second substrate comprises, towards the liquid crystal layer, a color filter layer including a black mask layer and a color film, a transparent electrode and an alignment layer in this order and
a member for covering at least a part of the color filter layer in a non-display region is provided,
wherein the black mask layer and the color film are disposed apart from the seal when the first substrate and the second substrate are viewed in plane.

2. The device of claim 1, wherein the seal is continuously disposed such that the seal surrounds the liquid crystal layer when the first substrate and the second substrate are viewed in plane.

3. The device of claim 2, wherein the member is disposed along the seal.

4. The device of claim 1, further comprising a columnar spacer for forming a cell gap of a liquid crystal panel, and
wherein the member is comprised of same material as the columnar spacer.

5. The device of claim 1, further comprising a columnar spacer for forming a cell gap of a liquid crystal panel, and wherein the height of the member is lower than the height of the columnar spacer.

6. The device of claim 5, wherein the member is comprised of same material as the columnar spacer.

7. The device of claim 1, wherein the member is formed directly on the color filter layer.
